(19) United States
(12) Patent Application Publication
(10) Pub. No.: US 2026/0249714 A1
(43) Pub. Date: Aug. 27, 2026

(54) CHARGING DEVICE AND CHARGING SYSTEM FOR AN ELECTRIC VEHICLE

(71) Applicant: MAHLE International GmbH, Stuttgart (DE)

(72) Inventors: Daniel Llanes, Valencia (ES); Juan Francisco Pardo Peris, Xàtiva (ES); Francisco Gonzalez Espin, La Pobla de Valbona (ES); Torbjorn Hallberg, Valencia (ES); Carlos Revert, Paterna (ES); Carlos Masia, Valencia (ES); Philip Grabherr, Stuttgart (DE)

(21) Appl. No.: 19/548,849

(22) Filed: Feb. 24, 2026

(30) Foreign Application Priority Data
Feb. 25, 2025 (DE) 102025107167.5

(51) Int. Cl. B60L 53/12; B60L 53/302; B60L 53/62; H02J 50/12; H02M 3/00; H02M 3/335

(52) U.S. Cl. CPC B60L 53/12; B60L 53/302; B60L 53/62; H02J 50/12; B60L 2210/30; B60L 2210/40; H02M 3/01; H02M 3/33573; H02M 3/33584

(57) ABSTRACT

A charging device configured to be mounted in an electric vehicle for charging a traction battery may include a wireless power transfer (WPT) unit, an on-board charging (OBC) unit, a rectifier configured to convert high-frequency AC power provided via the WPT unit and/or the OBC unit into DC power, an output unit configured to connect the rectifier to the traction battery of the electric vehicle to provide the DC power to the traction battery, and a switching unit configured to connect the high frequency AC power provided by the WPT unit and/or the OBC unit to the rectifier. The WPT unit may include a WPT input configured to receive electric power inductively received via a WPT receiving coil from a WPT transmitting coil and a WPT output configured to provide high-frequency AC power. The OBC unit may include an OBC input, a power conversion circuitry, and an OBC output.

### CROSS-REFERENCE TO RELATED APPLICATION

This application claims priority to German Patent Application No. DE102025107167.5, filed on Feb. 25, 2025, the contents of which is hereby incorporated by reference in its entirety.

### TECHNICAL FIELD

The present invention relates to a charging device that is configured to be mounted in an electric vehicle for charging a traction battery of the electric vehicle. The present invention relates further to a charging system and an electric vehicle.

### BACKGROUND

Electric vehicles (EVs) are typically charged through a charging cable that is plugged into a charging port of the EV. An on-board charging (OBC) unit converts the electric power, which may be DC or AC power, into DC power to charge the traction battery (also called high-voltage (HV) battery) of the EV and optionally a low-voltage (LV) battery. Wireless charging is envisaged by use of a wireless power transfer (WPT) system having a ground assembly (GA) having a transmitting coil, mounted within or on top of ground, and a vehicle assembly (VA) having a WPT unit and a receiving coil, mounted within or on top of the bottom of the EV, between which electric power can be inductively transferred. OBC units and WPT units are generally known.

If both charging units, i.e., OBC unit and WPT unit, are separately mounted inside an EV, sufficient space must be provided for their installation, including electrical harnesses and connectors for HV and LV supplies, communications, cooling hoses, connectors, etc.

### SUMMARY

It is an object of the present invention to reduce space and costs for installation of both charging units in EVs.

In a first aspect of the present invention a charging device is presented that is configured to be mounted in an electric vehicle for charging a traction battery of the electric vehicle, the charging device comprising:
a wireless power transfer (WPT) unit having a WPT input configured to receive electric power inductively received by a WPT receiving coil from a WPT transmitting coil and a WPT output configured to provide high-frequency AC power;
an on-board charging (OBC) unit having an OBC input configured to connect a power supply connector for supplying electric power from an electric power supply system, a power conversion circuitry configured to convert supplied electric power to high-frequency AC power, and an OBC output configured to provide the high-frequency AC power;
a rectifier configured to convert the high-frequency AC power provided by the WPT unit or the OBC unit into DC power;
an output unit configured to connect the rectifier to the traction battery of the electric vehicle to provide the DC power to the traction battery; and
a switching unit arranged between the WPT output, the OBC output and the rectifier, the switching unit being configured to connect the high frequency AC power provided by the WPT unit or the OBC unit to the rectifier.

In a further aspect of the present invention relates to an electric vehicle comprising a traction battery and a charging system as disclosed herein for charging the traction battery.

Preferred embodiments of the invention are defined in the dependent claims. It shall be understood that the claimed electric vehicle has similar and/or identical preferred embodiments as the claimed charging device, in particular as defined in the dependent claims and as disclosed herein.

The present invention is based on the idea that due to the resonant nature of the converters commonly used in the OBC unit and the WPT unit, and due to the fact that both charging units do generally not operate in parallel, it is possible to share blocks so that an integrated charging device is provided, e.g. in a single package, thus reducing volume, weight, and cost. By providing a switching unit that switches between the OBC unit and the WPT unit for charging, at least the rectifier of the OBC unit can be shared with the WPT unit.

In an embodiment the charging device further comprises a compensation network configured to compensate reactive power. The compensation network is coupled between the WPT input and the WPT output of the WPT unit. The compensation network may be arranged outside of the OBC unit or within the OBC unit. The latter embodiment particularly has the advantage that the size and/or the cooling needs of the WPT unit can be further reduced.

In another embodiment, the OBC unit further comprises a cooling connector configured to connect a heat exchanger. Since one or more components conventionally provided within the WPT unit are now shared with the OBC unit and preferably arranged within the OBC unit, a separate cooling connector for the WPT unit may thus be omitted.

In another embodiment, the OBC unit further comprises a control unit configured to control the switching unit. The control unit may further be configured to control the rectifier but may alternatively be configured as separate control unit. Another separate control unit for the WPT unit, as conventionally provided for controlling the rectifier of the WPT unit, may thus be omitted.

Preferably, the control unit is configured to detect if electric power is supplied to the OBC unit or the WPT unit and to control the switching unit accordingly. The detection may e.g. be implemented by measuring current or voltage provided at the OBC input or the OBC converter and by measuring current or voltage provided at the receiving coil of the WPT unit or and the WPT input of the OBC unit. If power is provided to the OBC unit, the switching unit is controlled to provide this power to the rectifier. If power is provided to the WPT unit, the switching unit is controlled to provide this power to the rectifier. Generally, charging via the OBC unit or the WPT unit is used at a time.

In another embodiment, the OBC unit is configured for bidirectional power transfer and comprises a CLLLC resonant converter (i.e. having an active rectifier) or the OBC unit is configured for unidirectional power transfer and comprises an LLC resonant converter (i.e. having a passive rectifier). The switching unit and the rectifier may thus be controlled accordingly to ensure the desired direction of power flow.

In another embodiment, the power conversion circuitry comprises one or more of an AC/DC converter, a DC/AC converter, a resonant tank, and a high-frequency transformer. These are typical components of charging devices and are provided depending on the desired use and application.

In another embodiment, the charging device may further comprise a housing that commonly houses the WPT unit and the OBC unit. This additionally saves space since no separate housings for the WPT unit and the OBC unit are provided.

In another embodiment, the OBC unit further comprises a low-voltage (LV) battery connector configured to connect the OBC unit to a low-voltage battery of the electric vehicle to receive power from the low-voltage battery (i.e. to supply the auxiliary circuits of the OBC unit and the WPT unit). The LV battery connector may also be used to communicate with the vehicle, e.g. via a CAN bus or any other communication network. This connection can be shared as well between the OBC unit and the WPT unit, i.e. no separate LV battery connector of the WPT unit is needed.

### BRIEF DESCRIPTION OF THE DRAWINGS

These and other aspects of the invention will be apparent from and elucidated with reference to the embodiment(s) described hereinafter. In the following drawings:

FIG. 1 shows a schematic diagram of the general layout of a WPT system for an EV;

FIG. 2 shows a schematic diagram of a generally known OBC system for an EV;

FIG. 3 shows a schematic diagram of a charging system in an EV including the WPT system and the OBC system 200 implemented separately;

FIG. 4 shows a first embodiment of a charging device and a charging system according to the present invention;

FIG. 5 shows a second embodiment of a charging device and a charging system according to the present invention;

FIG. 6 shows a flowchart of a method of controlling the switching unit; and

FIG. 7 shows a circuit diagram of a capacitor-inductor-inductor-inductor-capacitor (CLLLC) resonant converter for use as resonant tank.

### DETAILED DESCRIPTION

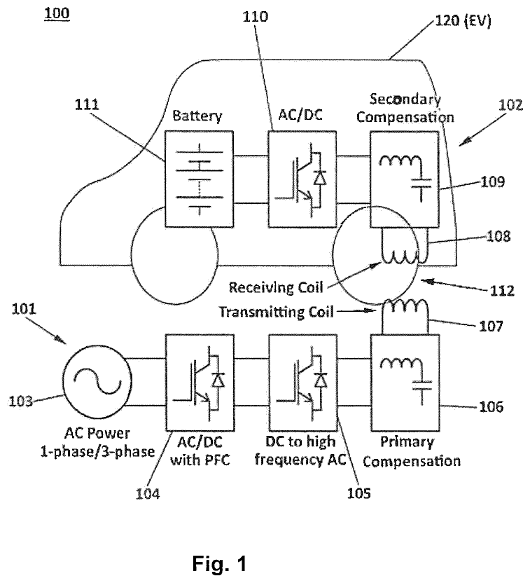

FIG. 1 shows a schematic diagram of a generally known WPT system 100 for an EV 120, as, e.g., disclosed in EP 3694079 A1. In this WPT system 100 the basic functional blocks for inductive charging are shared between a ground assembly (GA) 101 and a vehicle assembly (VA) 102, each of them representing a separate WPT device of the WPT system 100. The WPT system 100 comprises an inductive charging coil assembly 112 comprising a transmitter coil (also called transmitting coil or GA coil) 107 located at the GA side and a receiver coil (also called receiving coil or VA coil) 108 located at the vehicle side.

The GA 101 of the WPT system 100 comprises an AC/DC converter 104 with power factor correction (PFC) that converts the single or three phase power provided by an (external) AC power source 103 to a regulated DC power. The GA 101 further comprises a DC to high frequency (HF) AC converter 105 that generates a square wave voltage with nearly constant frequency and duty cycle. A primary compensation circuit 106, which is a passive circuit network, compensates the transmitter coil inductance in order to reduce the amount of reactive power delivered by the DC to HF AC converter 105. The transmitter coil 107 transmits power through a magnetic field and adds isolation between the AC power inlet and the vehicle high voltage (HV) battery 111 (also called traction battery).

The VA 102 comprises a receiver coil 108 that picks up power through the magnetic field and adds isolation between the AC power inlet and the vehicle HV battery 111. A secondary compensation circuit 109, which is a passive circuit network, compensates the receiving coil inductance in order to maximize the transferred power at electrical resonance. The VA 102 comprises an (active or passive) AC/DC rectifier 110 that converts high frequency AC current to DC current to charge the vehicle HV battery. A DC/DC battery charger (that may or may not include battery charging algorithms/charging strategy) may be provided. The VA 102 may comprise the HV battery 111 or be connected to the HV battery 111.

The architecture of the VA may differ depending upon many criteria, including network compensation or charging/discharging strategy. The charging of the high voltage battery 111 can potentially be handled by both assemblies, the GA 101 and the VA 102 of the WPT system 100, which design can determine an optimal WPT architecture.

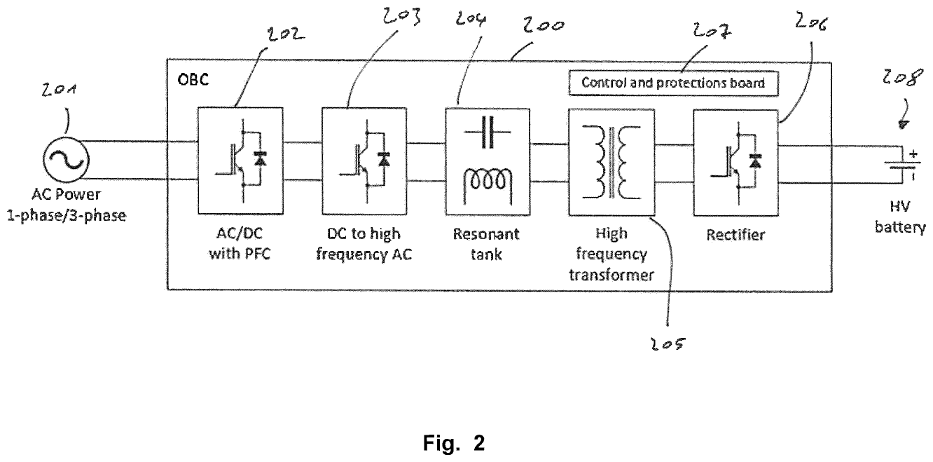

FIG. 2 shows a schematic diagram of a generally known OBC system 200 for an EV. It comprises an AC/DC converter 202 with PFC that converts the single or three phase power provided by an (external) AC power source 201 to a regulated DC power. The OBC system 200 further comprises a DC to high frequency (HF) AC converter 203 that generates a square wave voltage with variable or constant frequency depending upon the operating point of the battery and the requested power. A resonant tank 204 ensures power transfer at resonance to maximize power converter efficiency. A high frequency transformer 205 adds insulation between the AC network (components 203, 204) and the vehicle HV battery 208, which corresponds to the vehicle HV battery 111 shown in FIG. 1. A rectifier 206 converts high frequency AC current to DC current to charge the vehicle HV battery 208. It may be an active or passive rectifier, e.g., may use diodes, IGBTs, MOSFETS, etc. One or more control and protection board(s) 207 may be provided for control and protection of the components of the OBC system 200.

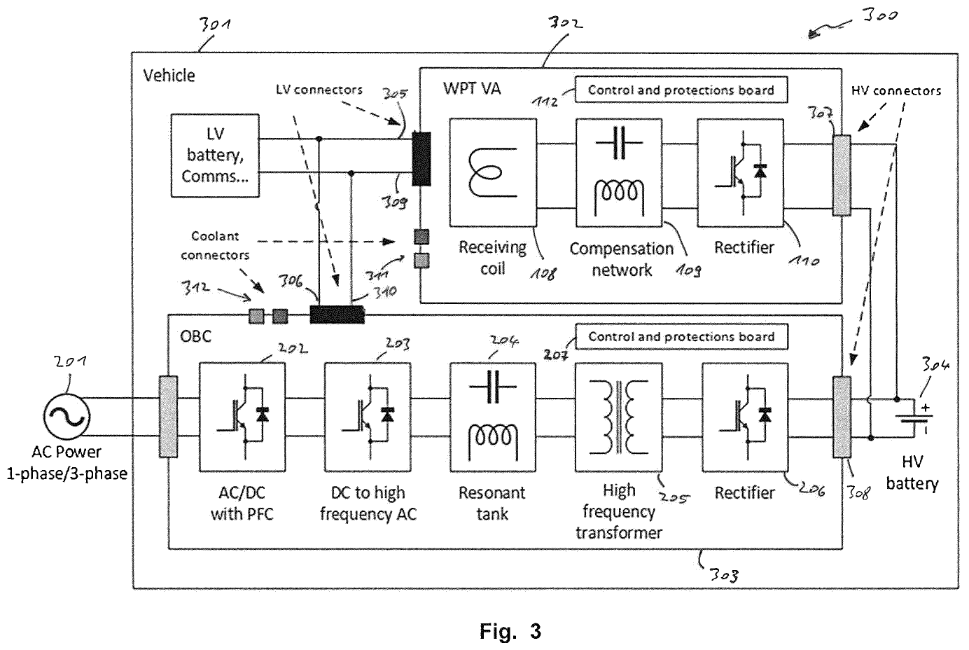

FIG. 3 shows a charging system 300 in an EV 301 configured under the assumption that both charging systems, i.e. the WPT VA 302 (which may be implemented and may operate like the VA 102 shown in FIG. 1) and the OBC system 303 (which may be implemented and may operate like the OBC system shown in FIG. 2), are used and implemented separately to charge the traction battery 304. In this case the EV 301 will have to allocate enough space for the installation of both charging systems 302, 303 including one or more of electrical harnesses (not shown), connectors for HV supplies 305, 306 and LV supplies 307, 308, connectors for communications 309, 310, cooling hoses and connectors 311, 312, etc. Furthermore, separate control 112, 207 is provided requiring arbitration and synchronization from a higher level. All this increases costs, complexity, space and other efforts.

Due to the resonant nature of the converters in both the OBC system and the WPT charging system and the fact that both charging systems do not operate in parallel, it is possible to share blocks so that an integrated charging device is presented by the present invention that is preferably implemented a single package, thus reducing complexity, volume, weight, and cost and providing an additional wireless charger feature as an add-on in a simple and cost-effective way.

One of the ideas of the present invention is that the power electronics circuits of the OBC system and the WPT VA are rather similar or even partly identical and that similar electronic circuits and features are used to make them work properly. This means that for one or more of these electronic circuits and feature common components can be used for both the OBC system and the WPT VA, such as one or more of a common microcontroller, a common low-power supply, common current and voltage sensors, common over-voltage and over-current protections, common temperature sensors, etc. Furthermore, those components can advantageously be used for both the OBC charging system and the WPT VA if they share the same housing/packaging because they do not work simultaneously in parallel. For instance, the same microcontroller/control unit can control the DC to HF AC unit of the OBC system and the rectifier in OBC mode or the rectifier in WPT charging mode. If two separate devices (OBC system and WPT VA) are used separately as in the charging system shown in FIG. 3, then two separate microcontrollers (112, 207 in FIG. 3) are needed that will not be working at once. The same holds for other components, including, for instance, busbars or cables from the respective rectifier (110, 206 in FIG. 3) to the HV battery 304.

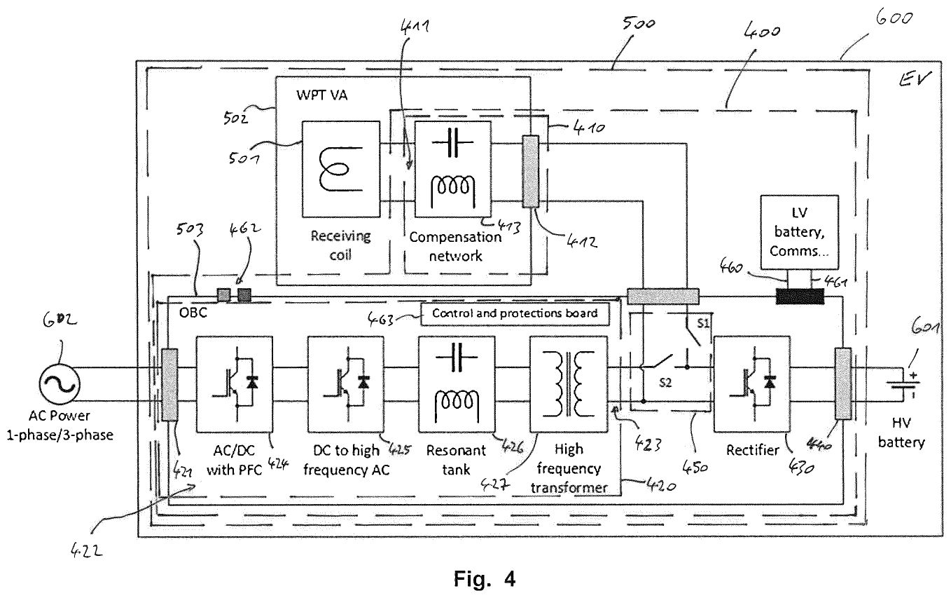

FIG. 4 shows an embodiment of a charging device 400 and a charging system 500 according to the present invention. The charging device 400 is mounted in an EV 600 for charging the traction battery 601 of the EV and comprises a WPT unit 410 and an OBC unit 420.

The WPT unit 410 has a WPT input 411 that receives electric power inductively received by the WPT receiving coil 501, which is part of the charging system 501 but not of the charging device 400, from a WPT transmitting coil (not shown; 107 in FIG. 1) and a WPT output 412 that provides high-frequency AC power. Further, in this embodiment the WPT unit 410 comprises a compensation network 413, in particular for compensation of reactive power, which may be implemented and may operate like the compensation network 109 shown in FIG. 1. The WPT unit 410 and the WPT receiving coil 501 represent the WPT VA 502

The OBC unit 420 has an OBC input 421 that connects an external power supply connector (not shown) for supplying electric power from an external electric power supply system 602 (e.g. the AC power supply 201 shown in FIG. 2), a power conversion circuitry 422 that converts supplied electric power to high-frequency AC power, and an OBC output 423 that provides the high-frequency AC power. The power conversion circuitry 422 preferably includes an AC/DC converter 424, a DC to HF AC converter 425, a resonant tank 426 and a HF transformer 427, which may be implemented and may operate like the components 202 to 205 shown in FIG. 2.

The charging device 400 further comprises a (common) rectifier 430 (active or passive) that converts the HF AC power provided by either the WPT unit 410 or the OBC unit 420 into DC power. An (common) output unit 440 is provided as HV battery connector to connect the rectifier 430 to the traction battery 601 of the EV 600 to provide the DC power to the traction battery 601 for charging it. A switching unit 450 is arranged between the WPT output 412, the OBC output 423 and the rectifier 430 to connect the HF AC power provided by either the WPT unit 410 or the OBC unit 420 to the rectifier 430. The switching unit 450 preferably comprises two switches S1, S2 that can be controlled to connect the HF AC power provided by either the WPT unit 410 or the OBC unit 420 to the rectifier 430.

The rectifier 430, the output unit 440 and the switching unit 450 may be separate components, but one or more of them may be part of the OBC system 503.

In the exemplary embodiment shown in FIG. 4, further components are shared between the

WPT unit 410 and the OBC unit 420, in particular, a connector for LV supply 460, a connector for communications 461 (which may be implemented as common connector with the connector for LV supply 460), cooling hoses and connectors 462 for heat exchange and cooling, and a control and protections board 463. In this exemplary embodiment, the WPT VA 502 is assumed to be cooled down passively through natural convention and conduction trough the chassis to the vehicle, thus sharing the coolant circuit of the receiving coil 501. However, if additional cooling is needed, the WPT VA 502 could include a coolant-based heat exchanger (not shown) as well. A common control unit, e.g. the control and protections board 463, may be configured to control the switches S1, S2 of the switching unit 450 and the generally used switching elements of the rectifier 430, which may be implemented as a full-bridge rectifier.

In preferred embodiments of the disclosed charging device and charging system one or more of the following components can be shared: housing/packaging (preferably the complete charging device 400 is included in a common housing or package), a busbar, and an electric harness.

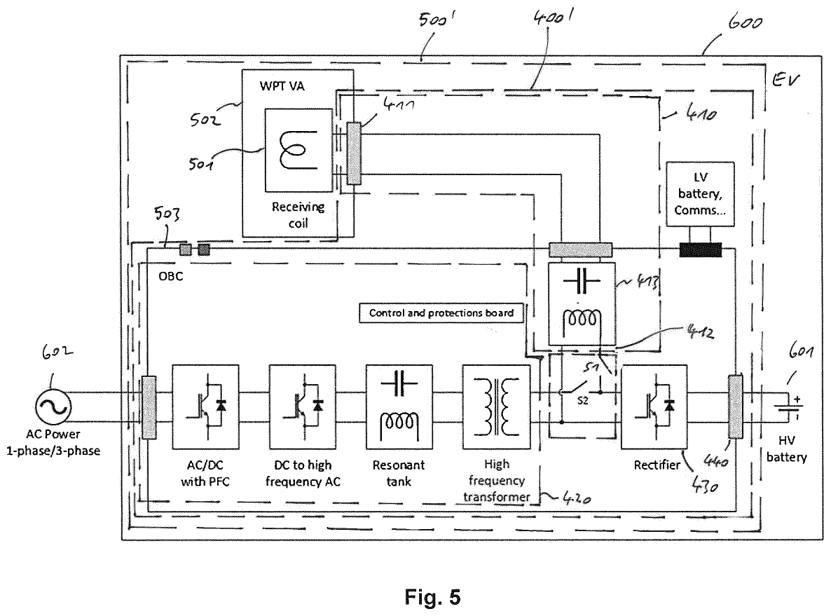

FIG. 5 shows another embodiment of a charging device 400′ and a charging system 500′ according to the present invention. Different from the charging device 400 shown in FIG. 4, the compensation network 413 is part of the OBC system 503, which further reduces the size of the WPT VA 502 and the cooling needs. All other components of the charging device 400′ and the charging system 500′ are generally configured in the same way as explained above with reference to the first embodiment illustrated in FIG. 4.

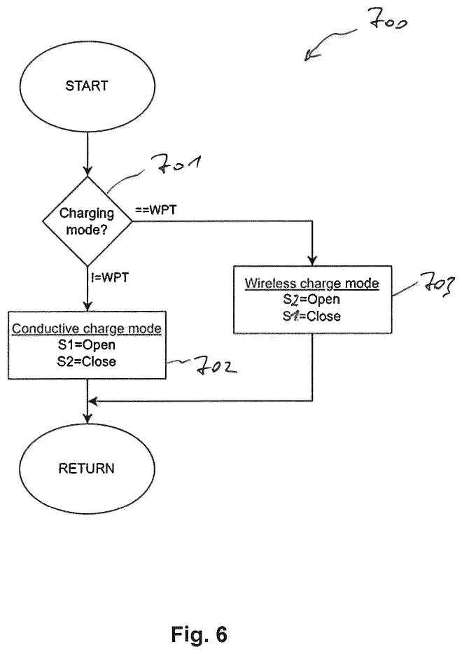

FIG. 6 shows a flowchart of a method 700 of controlling the switching unit 450. In a first step 701 the charging mode is checked, e.g. by detecting if electric power is supplied to the OBC unit or the WPT unit. If the charging mode is the conductive charging mode (via the OBC unit), in step 702 the switching elements of the switching unit 450 are controlled such that S1 is open and S2 is closed. If the charging mode is the wireless charging mode (via the WPT unit), in step 703 the switching elements of the switching unit 450 are controlled such that S1 is closed and S2 is open. A vehicle control unit may be the master communication unit for the charging process and may be responsible for sharing the charging mode to the control unit that will ultimately control the switching and the charging process through the OBC unit or the WPT unit. After the charging process the method returns (step 704) to the initial state.

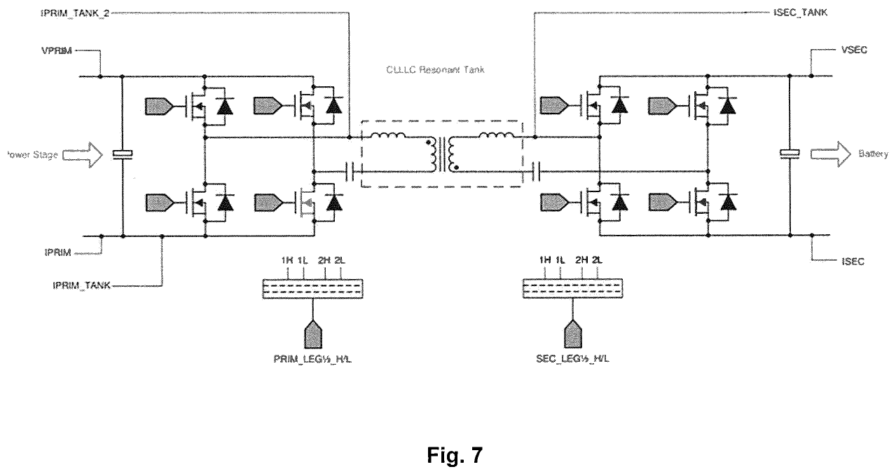

FIG. 7 shows a circuit diagram of a capacitor-inductor-inductor-inductor-capacitor (CLLLC) resonant converter (i.e. having an active rectifier) as an exemplary implementation of the resonant tank (426 in FIG. 4) of the OBC unit. Such an implementation allows bidirectional power flow through the OBC unit. Other implementations may be used as well. In another embodiment, the resonant tank may be implemented as LLC resonant converter (i.e. having a passive rectifier).

The charging device and system according to the present invention provide for reduced volume, reduced weight, and reduced cost. Further, they provide a solution to be easily offered as a cost-effective add-on to the conventional OBC charging device.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A charging device configured to be mounted in an electric vehicle for charging a traction battery of the electric vehicle, the charging device comprising:
a wireless power transfer (WPT) unit including a WPT input configured to receive electric power inductively received via a WPT receiving coil from a WPT transmitting coil and a WPT output configured to provide high-frequency AC power;
an on-board charging (OBC) unit including:
an OBC input configured to connect a power supply connector for supplying electric power from an electric power supply system;
a power conversion circuitry configured to convert supplied electric power to high-frequency AC power; and
an OBC output configured to provide the high-frequency AC power;
a rectifier configured to convert the high-frequency AC power provided via the WPT unit and/or the OBC unit into DC power;
an output unit configured to connect the rectifier to the traction battery of the electric vehicle to provide the DC power to the traction battery; and
a switching unit arranged between the WPT output, the OBC output, and the rectifier, the switching unit configured to connect the high-frequency AC power provided by the WPT unit and/or the OBC unit to the rectifier.

2. The charging device according to claim 1, further comprising a compensation network configured to compensate reactive power, the compensation network coupled between the WPT input and the WPT output.

3. The charging device according to claim 2, wherein the compensation network is arranged outside of the OBC unit.

4. The charging device according to claim 1, wherein the switching unit, the rectifier, and/or the output unit are part of the OBC unit.

5. The charging device according to claim 1, further comprising a cooling connector configured to connect a heat exchanger.

6. The charging device according to claim 1, further comprising a controller configured to control the switching unit.

7. The charging device according to claim 6, wherein the controller is further configured to detect if electric power is supplied to the OBC unit and/or the WPT unit and to control the switching unit accordingly.

8. The charging device according to claim 6, wherein the controller is further configured to control the WPT unit and the OBC unit.

9. The charging device according to claim 1, wherein the OBC unit is configured for bidirectional power transfer and further includes a CLLLC resonant converter.

10. The charging device according to claim 1, wherein the power conversion circuitry includes an AC/DC converter, a DC/AC converter, a resonant tank, and/or a high-frequency transformer.

11. The charging device according to claim 1, further comprising a housing that commonly houses the WPT unit and the OBC unit.

12. The charging device according to claim 1, further comprising a low-voltage input configured to receive low-voltage power.

13. The charging device according to claim 1, wherein the OBC unit further includes:
a cooling connector configured to connect a heat exchanger;
a controller configured to control the switching unit;
a low-voltage input configured to receive low-voltage power; and/or
a communication input.

14. A charging system, comprising:
a wireless power transfer (WPT) receiving coil configured to inductively receive electrical energy from a WPT transmitting coil; and
a charging device according to claim 1.

15. An electric vehicle, comprising a traction battery and a charging system according to claim 14 for charging the traction battery.

16. The charging device according to claim 2, wherein the compensation network is arranged within the OBC unit.

17. The charging device according to claim 1, wherein the OBC unit is configured for unidirectional power transfer and further includes an LLC resonant converter.

18. A charging device configured to be mounted in an electric vehicle for charging a traction battery of the electric vehicle, the charging device comprising:
a wireless power transfer (WPT) unit including:
a WPT input configured to receive electric power inductively received via a WPT receiving coil from a WPT transmitting coil; and
a WPT output configured to provide a first high-frequency AC power;
an on-board charging (OBC) unit including:
an OBC input connectable to a power supply connector for supplying electric power from an electric power supply system;
a power conversion circuitry configured to convert the supplied electric power to a second high-frequency AC power; and
an OBC output configured to provide the second high-frequency AC power;
a rectifier configured to convert the first high-frequency AC power provided via the WPT unit and/or the second high-frequency AC power provided via the OBC unit into DC power;
an output unit via which the rectifier is connectable to the traction battery of the electric vehicle to provide the DC power to the traction battery; and
a switching unit arranged between the WPT output, the OBC output, and the rectifier;
wherein the switching unit includes a plurality of switches that are controllable to connect the first high-frequency AC power provided by the WPT unit and/or the second high-frequency AC power provided by the OBC unit to the rectifier.

19. The charging device according to claim 18, wherein the switching unit, the rectifier, and the output unit are structured separately from the OBC unit.

20. The charging device according to claim 18, further comprising a controller configured to:
measure current and/or voltage at the WPT input and, when electrical power is detected at the WPT input, adjust at least one of the plurality of switches to provide the first high-frequency AC power provided by the WPT unit to the rectifier; and
measure current and/or voltage at the OBC input and/or the power conversion circuitry and, when electrical power is detected at the OBC input and/or the power conversion circuitry, adjust at least one of the plurality of switches to provide the second high-frequency AC power provided by the OBC unit to the rectifier.
